(19) United States
(12) Patent Application Publication
(10) Pub. No.: US 2014/0282062 A1
(43) Pub. Date: Sep. 18, 2014

(54) TECHNIQUES FOR EFFICIENT AND GRANULAR COMPOSITION OF A USER PROFILE

(71) Applicant: MICROSOFT CORPORATION, Redmond, WA (US)

(72) Inventors: Amrish Sushil Kapoor, Salt Lake City, UT (US); David Lenn Jackman, Cedar Hills, UT (US); Michael Eric Lasky, Orem, UT (US); Russell Young, Pleasant Grove, UT (US); Adam Brady Anderson, Boston, MA (US)

(73) Assignee: Microsoft Corporation, Redmond, WA (US)

(21) Appl. No.: 13/834,147

(22) Filed: Mar. 15, 2013

(51) Int. Cl. H04L 29/08

(52) U.S. Cl. CPC H04L 67/10
USPC 715/745

(57) ABSTRACT

Techniques are provided for customizing user settings for applications. Each user profile includes one or more packages that each includes user settings for one or more applications. Each package may be application specific, may be directed to common settings for an application suite, or may contain functional groups of user settings. For each application, a template may be stored that is associated with the application. The template identifies the application and indicates locations where the application stores the user settings. An agent may be associated with a trigger mechanism. The agent is configured to access the template of the application and to open a corresponding package at a central storage location if the trigger mechanism is triggered. The agent is configured to apply the user settings included in the package to the application at the locations indicated in the template.

### BACKGROUND

A roaming user profile (“RUP”) is a type of user profile that enables users to access multiple computers in a same network with a consistent computing environment experience. A RUP stores a common set of user profile settings for the user, and may be accessed by each computer in the network to provide the common set of user profile settings across the computers. In this manner, the user may have a consistent desktop experience, such as by applications being automatically configured with particular preferred colors, window positions, and/or other user preferences defined by the user profile settings.

Typically, a RUP stores all of a user's profile data and settings in a central location as one unit. When a user logs on, the entire stored RUP is downloaded from the central location, and all the settings in the RUP are put in place so that the user has their entire profile setup. Similarly, when the user logs off, the settings that form the user's RUP are collected and pushed back out to the central location.

As such, because all the settings are stored as a single unit, and the RUP grows larger over time as profile data is added, the time taken to download and upload the RUP during logon and logoff increases over time. This leads to a very poor user experience when the RUP becomes particularly large. Furthermore, because the settings are stored together, if the single-unit RUP is corrupted, the entire user profile may be corrupted, which can render a computer system unusable. Still further, the use of a single-unit RUP leads to brittleness towards communication errors during upload and download of the RUP, which can also cause data loss and unusable computer systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for user profiles, including roaming user profiles, that enable granular access and provide greater flexibility. Settings of a user profile are divided into different groups or “packages,” with each package being associated with and controlled by a corresponding application to which the settings apply. User settings of a particular package may be downloaded or uploaded at one or more trigger points, rather than downloading or uploading all of the user settings of the user profile. A first type of package may contain user settings specific to a particular application. A second type of package may be a “common” package that contains common user settings for an application suite that includes multiple applications. A third type of package may contain a functional group of user settings. The functional group of user settings is accessible by a plurality of applications, with each application having a corresponding set of user settings in the functional group of user settings.

In one implementation, a method for customizing user settings for applications is provided. A storage location for storing user profiles is selected. Each user profile includes one or more packages that each includes user settings for one or more applications. For at least one application on each computing device of a plurality of computing devices, a template may be stored that is associated with the application. The template identifies the application and indicates locations where the application stores the user settings. Furthermore, an agent may be associated with a trigger mechanism. The agent is configured to access the template associated with the application and to open a corresponding package at the selected storage location if the trigger mechanism is triggered (e.g., when the application is opened, etc.). The agent is configured to apply the user settings included in the package to the application at the locations indicated in the template.

Furthermore, an agent may be associated with another type of trigger mechanism (e.g., when the application is closed, etc.). The agent is configured to access the template associated with the application. The agent is configured to collect the user settings at the locations indicated in the template, and to provide the collected user settings to be included in the package.

Note that the agent may be associated with a trigger mechanism in many ways, such as by inserting an agent into at least one of a startup routine or a shutdown routine of the application, inserting an agent into at least one of a login routine or a logoff routine of the application, inserting an agent into at least one of a lock routine or an unlock routine of the application, inserting an agent into at least one of a sleep routine or a wake routine of the application, or inserting an agent into at least one of a session connect routine or a session disconnect routine of the application.

In another implementation, a method in an agent is provided. A template is accessed in response to a trigger mechanism being triggered with respect to an application in a computing device. The template identifies the application and indicates locations where the application stores the user settings. A package is accessed that includes the user settings at a storage location. The package is included in a user profile at the storage location that includes a plurality of packages that each includes user settings for one or more applications. The user settings included in the package are applied to the application at the locations indicated in the template. Alternately, for another type of trigger mechanism, the user settings may be collected from the locations indicated in the template, and provided to be included in the package.

In still another implementation, an application settings customization system is provided. The application settings customization system includes a configuration interface that includes an administrator interface and an application customizer. The administrator interface enables a storage location to be selected for storing user profiles. Each user profile includes one or more packages that each includes user settings for one or more applications. The application customizer is configured to store a template at a computing device in association with an application. The template identifies the application and indicates locations where the application stores the user settings. The application customizer is further configured to associate an agent for the application with a trigger mechanism. The agent is configured to access the template associated with the application and to open a corresponding package at the selected storage location if the trigger mechanism is triggered. The agent is configured to apply the user settings included in the package to the application at the locations indicated in the template. Alternately, for another type of trigger mechanism, the agent is configured to collect the user settings at the locations indicated in the template, and to provide the collected user settings to be included in the package.

Furthermore, the application customizer may be configured to install a filter driver at the computing device. The filter driver is configured to automatically associate agents with applications at the computing device.

Still further, the application settings customization system may further include a package distributer configured to respond to requests for packages from agents generated in response to trigger mechanisms being triggered with respect to applications.

A computer readable storage medium is also disclosed herein having computer program instructions stored therein that enable a processor to configure applications and computing devices to access user settings in the forms of packages, to operate an agent, and to enable additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a communication system that enables applications to be configured with user settings in the form of packages, according to an example embodiment.

FIG. 2 shows a block diagram of storage containing user profiles that include user settings organized in packages, according to an example embodiment.

FIG. 3 shows a flowchart providing a process for setting up applications to access user settings organized in packages, according to an example embodiment.

FIG. 4 shows a block diagram of a communication system in which a configuration interface enables applications to be set up to access user settings organized in packages, according to an example embodiment.

FIG. 5 shows a flowchart providing a process for an application being configured by an agent with user settings included in a package in response to a trigger mechanism being triggered, according to an example embodiment.

FIG. 6 shows a block diagram of a communication system in which an application is configured by an agent with user settings included in a package in response to a trigger mechanism being triggered, according to an example embodiment.

FIG. 7 shows a block diagram of an example computing device that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A roaming user profile (“RUP”) is a type of user profile that enables users to access multiple computers in a same network with a consistent computing environment experience. A RUP stores a common set of user profile settings for the user, and may be accessed by each computer in the network to provide the common set of user profile settings across the computers. In this manner, the user may have a consistent desktop experience, such as by applications at different computer systems being automatically configured with the same preferred colors, window positions, and/or other user preferences defined by the user profile settings.

A conventional RUP stores all of a user's profile data and settings in a central location as one unit such that when a user logs on, the entire stored RUP is downloaded from the central location. Similarly, when the user logs off, the settings that form the user's RUP are collected and pushed back out to the stored RUP at the central location. Whenever the user creates new settings for any applications, the new settings are stored in the user's RUP, causing the RUP to gradually grow in size. As such, conventional RUPs suffer from a gradually growing download and upload time, the possibility of an entire user profile being corrupted, and brittleness towards communication errors.

Embodiments described herein provide user profiles that overcome the disadvantages of conventional RUPs. In embodiments, settings of a user profile are divided into different groups or “packages,” with each package being associated with and controlled by a corresponding application to which the settings apply. As such, these user profiles are more granular than single-unit conventional RUPs. A particular package may be downloaded or uploaded at one or more trigger points related to the application, in real-time, to provide the particular user settings to the application, rather than downloading or uploading the entire user profile. Because of the granular nature of the packages, user profiles based on packages suffer less from the gradually increasing size problem of single-unit conventional RUPs. This package-based user profile configuration also avoids the problem of a corrupted RUP causing a user to lose their entire user profile. Instead, if a particular package becomes corrupted, other packages of the user profile directed to other applications are not affected. Furthermore, because the packages may be centrally located and network accessible, user profile embodiments can be accessed by multiple computing devices across a network to provide a user with a consistent computing environment across different computing devices.

According to embodiments, one or more different types of packages may be present in a user's profile. For instance, a first type of package may contain user settings specific to a particular application. A second type of package may be a “common” package or “application suite” package that contains user settings for an application suite that includes multiple applications. The user settings of the application suite package are applicable to all of the applications in the application suite. A third type of package may contain a functional group of user settings. The functional group of user settings is accessible by a plurality of applications, with each application controlling a corresponding set of user settings in the functional group of user settings.

Still further, according to embodiments, a greater variety of events or “triggers” (“events” and “triggers” are used interchangeably herein) associated with applications may control when the user settings of packages are downloaded and uploaded. For instance, a package may be triggered to be downloaded during a logon event, a logoff event, a lock event, an unlock event, a sleep event, a wake event, a session connect event, a session disconnect event, a startup event, a shutdown event, a file open event, a file save event, or other event associated with an application.

Even further, events or triggers may be used to control the frequency at which user settings are applied to applications. For example, some settings that change more frequently (e.g., schedule settings in a calendar) may be triggered more frequently than settings that change less often (e.g., a background color setting in a word processing application). Furthermore, because the upload and download of users settings may be performed separately for each application, different settings can be defined to be handled differently from each other. For example, changed user settings such as bookmarks (e.g., in a browser) can be merged with their previous state in a package, whereas changed users settings such as background color can overwrite their previous setting instance in a package.

Such embodiments may be implemented in a variety of environments. For instance, FIG. 1 shows a block diagram of a communication system 100 that enables applications to be configured with user settings in the form of packages, according to an example embodiment. As shown in FIG. 1, system 100 includes first and second computing devices 102a and 102b, a server 104, storage 106, and a network 108. As further shown in FIG. 1, computing device 102a includes first and second applications 118a and 118b and first and second templates 120a and 120b. Computing device 102b includes third and fourth applications 118c and 118d and third and fourth templates 120c and 120d. Application 118a is associated with a first agent 122a, application 118b is associated with a second agent 122b, application 118c is associated with a third agent 122c, and application 118d is associated with a fourth agent 122d. Still further, server 104 includes an application settings customization system 124, which includes a configuration interface 110 and a package distributer 112. These features of communication system 100 are described as follows.

Computing devices 102a and 102b may each be any type of stationary or mobile computing device, including a desktop computer (e.g., a personal computer, etc.), a mobile computer or computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a Google Android™ phone, a Palm® device, a RIM Blackberry® device, etc.), or other type of mobile device. Server 104 may be implemented in one or more computer systems, including one or more servers which may be any type of computing devices described herein or otherwise known that is/are capable of enabling the corresponding functionality described herein.

Computing devices 102a and 102b and server 104 are communicatively coupled by network 108. Network 108 may include one or more communication links and/or communication networks, such as a PAN (personal area network), a LAN (local area network), a WAN (wide area network), or a combination of networks, such as the Internet. Computing devices 102a and 102b, and server 104 may be communicatively coupled to network 108 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Computing devices 102a and 102b are each associated with a corresponding user that interacts with the respective computing device as described herein. Two computing devices 102a and 102b are shown in FIG. 1 for purposes of illustration. Any number of computing devices may be present in system 100, including tens, hundreds, thousands, and even greater numbers of computing devices. Each computing device may operate one or more corresponding applications.

As shown in FIG. 1, storage 106 is coupled to server 104. Storage 106 may be directly connected to server 104, or may be coupled to server 104 through network 108. Storage 106 stores user profiles, including first-third user profiles 114a-114c. Storage 106 may have the format of a database or other format, and may include one or more of any type of storage mechanism to store user profiles, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Computing devices 102a and 102b are computing devices used by associated persons for any number and type of functions. For example, a first user at computing device 102a may interact with applications 118a and 118b, and a second user at computing device 102b may interact with applications 118c and 118d. Although two applications are shown in FIG. 1 that execute on each of computing devices 102a and 102b, any number of applications may be present in each of computing devices 102 and 102b, including tens, hundreds, and even greater numbers of applications. Examples of applications 118a-118d are mentioned elsewhere herein for purposes of illustration.

The first and second users may have preferences for settings of applications 118a-118d that they have determined themselves and/or may have preferences for settings of applications 118a-118d that are determined for them by an administrator. Such settings are referred to as “user settings”. Examples of user settings include background colors, default fonts, default font sizes, pointer speeds, view settings, sounds, etc. An application may have any number of settings, including hundreds, thousands, or even greater numbers of user settings that may be determined. Such user settings may be stored in user profiles for the first and second users. According to embodiments, the user settings may be stored in the user profiles organized in the form of packages, with each package corresponding to one or more applications. At one or more trigger events, a package of user settings may be downloaded to configure an application (e.g., when the application is started, etc.), or the user settings of the application may be collected and stored in a package (e.g., when the application is shutdown, etc.)

For example, as shown in FIG. 1, storage 106 may store user profiles, such as user profiles 114a-114c. User profile 114a may contain user settings for the first user and user profile 114b may include user settings for the second user. Furthermore, as shown in FIG. 1, each user profile may include one or more packages, such as user profile 114a including a first package 116a and a second package 116b. Although two packages are shown included in user profile 114a in FIG. 1, any number of packages may be present in each user profile, including tens, hundreds, and even greater numbers of packages. In one example, package 116a may include user settings for application 118a and package 116b may include user settings for application 118b. In other examples, package 116a and/or package 116b may include user settings for multiple applications.

For instance, FIG. 2 shows a block diagram of storage 106 containing user profiles that include user settings organized in packages, according to an example embodiment. As shown in FIG. 2, storage 106 includes first-third user profiles 114a-114c, and first user profile 114a includes a first package 116a, a second package 116b, and a third package 116c. In the example of FIG. 2, packages 116a-116c are three different types of packages, which are described as follows.

Package 116a is a first type of package that may contain user settings specific to a particular application. For instance, as shown in FIG. 2, package 116a includes application-specific user settings 202. Application-specific user settings 202 include one or more user settings for a single application. Thus, package 116a is directed to providing user settings for a single application. The single application may be considered to control or “own” application-specific user settings 202. Upon the occurrence of a trigger, application-specific user settings 202 may be applied to the application from package 116a, as described herein. Upon the occurrence of another trigger, user settings may be collected from the application, and provided to package 116a as application-specific user settings 202.

For instance, application 118a of FIG. 1 may be a calculator application, and package 116a of FIG. 2 may contain user settings specifically for the calculator application as application-specific user settings 202. In such an embodiment, package 116a does not contain user settings for any other application.

Package 116b is a second type of package that is a “common” package containing common user settings for an application suite that includes multiple applications. For instance, as shown in FIG. 2, package 116b includes application suite user settings 204. Application suite user settings 204 include one or more common user settings for multiple applications. Thus, package 116b is directed to providing common user settings for a multiple applications that form a suite of applications. As shown in FIG. 2, application suite user settings 204 include common settings 208. Common settings 208 include user settings that are applied to (common to) each application of the application suite. The user settings of common settings 208 may be applied to an application of the application suite, in addition to application-specific user settings for the application being applied to the application from an application-specific package. Thus, when a trigger occurs with respect to an application of the application suite, common settings 208 are applied to the application, and application-specific user settings for the application (e.g., application-specific user settings 202 in package 116a) corresponding to the application are also applied to the application. Upon the occurrence of another trigger, application-specific user settings may be collected from the application, and provided to package 116b as application-specific user settings for inclusion in the corresponding application-specific package (e.g., package 116a). Furthermore, any user settings common to the application suite may be collected from the application, and provided to package 116b to be included in common settings 208.

For instance, application 118b of FIG. 1 may be an application included in a suite, such as one of Microsoft® Word, Microsoft® PowerPoint, or Microsoft® Excel included in Microsoft® Office. A background color setting may be a common user setting across the applications of Microsoft® Office, and thus may be a user setting included in common settings 208. Furthermore, Microsoft® Word may include an application-specific user setting such as user settings for a particular Microsoft® Word-specific toolbar, which may be included in application-specific user settings 202 as application-specific settings for Microsoft® Word.

Note that in embodiments, any number of applications may have application-specific settings (such as application-specific user settings 202). Furthermore, any of such applications may be included in an application suite, and therefore may also have common user settings that are applicable thereto (such as common settings 208 included in application suite user settings 204) for a particular application suite. An application suite may include any number of applications that share common settings, including one application, two applications, or greater numbers of applications (e.g., tens, hundreds, etc.).

Package 116c is a third type of package that contains a functional group of user settings. The functional group of user settings is accessible by a plurality of applications, with each application having a corresponding set of user settings in the functional group of user settings. For instance, as shown in FIG. 2, package 116c includes user settings functional group 206. User settings functional group 206 includes one or more user settings for multiple applications, with the user settings exposing different views of themselves to the applications. As shown in FIG. 2, user settings functional group 206 includes first application controlled settings 212a and second application controlled settings 212b. Common settings may be included in user settings functional group 206, similarly to an application suite package, as well as user settings functional group 206 including application-specific user settings. When a trigger occurs with respect to an application having user settings in user settings functional group 206, common settings (when present) and one of application controlled settings 212a and 212b (or other set of application-specific user settings in package 116c) corresponding to the application are applied to the application. Upon the occurrence of another trigger, application-specific user settings may be collected from the application, and provided to package 116c as application-specific user settings for inclusion in the corresponding one of application controlled settings 212a or 212b (or other set of application-specific user settings in package 116c).

For instance, applications 118c and 118d of FIG. 1 may each be an application having user settings included in a functional group, such as the functional group “accessibility settings.” In such case, an example of application 118c may be a shell application that controls user settings in first application controlled settings 212a that are associated with the visual display, and an example of application 118d is ATbroker.exe, which may control user settings in second application controlled settings 212b associated with actual activation. Thus, with regard to user settings functional group 206, multiple applications may each access and control a portion of the total of user settings in a package.

Note that in embodiments, any number of applications may have application-specific settings included in user settings functional group 206, including application-specific settings for one application, for two applications, or for greater numbers of applications (e.g., tens, hundreds, etc.).

Referring back to FIG. 1, when a trigger mechanism is triggered with respect to an application, such as one of applications 118a-118d at computing devices 102a and 102b, embodiments cause user settings to be downloaded and applied to the application, or collected and uploaded from the application. In an embodiment, an agent may be associated with a trigger mechanism, such that when the trigger mechanism is triggered, the user settings are downloaded or uploaded by the agent. For example, as shown in FIG. 1, agent 122a may be associated with a trigger mechanism of application 118a, agent 122b may be associated with a trigger mechanism of application 118b, agent 122c may be associated with a trigger mechanism of application 118c, and agent 122d may be associated with a trigger mechanism of application 118d. In each case, when the trigger mechanism is triggered, the agent may access a corresponding template to determine locations at which user settings are to be applied to the application. For instance, as shown in FIG. 1, agent 122a may access template 120a, agent 122b may access template 120b, agent 122c may access template 120c, and agent 122d may access template 120d. Upon occurrence of the corresponding trigger, the agent may access the package corresponding to the application, and may apply the user settings of the package to the application at the locations indicated by the template.

As shown in FIG. 1, agents at computing devices 102a and 102b may access packages stored in storage 106 by communicating with application settings customization system 124 in server 106 over network 108. In particular, package distributer 112 may receive a package access 126 from an agent at computing device 102a, and may provide the package indicated in package access 126 to the agent in a package response 128.

Package access 126 and package response 128 may be communicated between a computing device and package distributer 112 at server 104 through network 108 in any manner. For instance, a user profile, such as user profile 114a, may be stored in storage 106 in a directory structure, with each package of the user profile stored as a separate file. In such case, package access 126 may be an open of the file representing the package, and package response 128 may include the file/user settings included in the file for the agent. The agent may maintain an indication of a storage location of the user profile in storage 106 (e.g., the agent may maintain a storage directory or path for the storage location), and may determine the name of the package file from the corresponding template. For instance, an identifier for the template (a template identifier) may indicate the package filename at the storage location. In other embodiments, package access 126 and package response 128 may be communicated in signals through network 108 in other ways, such as by TCP/IP (Transmission Control Protocol/Internet Protocol), User Datagram Protocol (UDP), etc., according to any suitable file transfer protocol, including FTP (File Transfer Protocol), HTTP (Hypertext Transfer Protocol), etc.

Applications may be set up in any manner by application settings customization system 124 to access user settings in packages using agents and templates. For instance, in an embodiment, configuration interface 110 may be interacted with by an administrator (a user) to configure one or more applications at computing devices, such as computing devices 102a and 102b, to access user settings in packages stored in storage 106. For example, in an embodiment, configuration interface 110 may enable an administrator to select the location for storing user profiles in storage 106, and may enable agents and templates to be associated with applications at the computing devices, so that at various trigger events, user settings are downloaded or uploaded to the applications using packages stored in the user profiles.

Elements of communication system 100 shown in FIG. 1 may be configured in various ways, in embodiments. For instance, example embodiments for setting up applications, as well as example embodiments for agents, templates, packages, and applications are described in the following subsections.

A. Example Embodiments for Setting Up Applications to Access Custom User Settings

As described above, in embodiments, applications can be set up to access user settings in the form of packages. Such set up can be performed in various ways. For instance, FIG. 3 shows a flowchart providing a process for setting up applications to access user settings organized in packages, according to an example embodiment. Configuration interface 110 of FIG. 1 may operate according to flowchart 300, in an embodiment. For purposes of illustration, flowchart 300 of FIG. 3 is described with respect to FIG. 4. FIG. 4 shows a block diagram of a portion of communication system 100 of FIG. 1, in which configuration interface 110 enables applications to be set up to access user settings organized in packages, according to an example embodiment. Computing device 102a and server 104 are shown in FIG. 4. As shown in FIG. 4, server 104 includes configuration interface 110, which includes an administrator interface 402 and an application customizer 404. Flowchart 200 and configuration interface 110 of FIG. 4 are described as follows. Note that the steps of flowchart 300 may be performed in orders other than the order shown in FIG. 3. Further structural and operational embodiments will be apparent to persons skilled in the relevant art(s) based on the following description.

Flowchart 300 begins with step 302. In step 302, a storage location for storing user profiles is selected. For instance, in an embodiment, administrator interface 402 may enable an administrator to select the location for storing user profiles in storage 106 (e.g., a “central storage location” or “central location”). In an embodiment, administrator interface 402 may generate a user interface 406, which may be interacted with by the administrator to select the storage location in storage 106. For instance, server 104 may operate a web browser that renders user interface 406 based on a web document provided by administrator interface 402. Alternatively, user interface 406 may be generated in other ways.

It is noted that administrator interface 402 may enable the administrator to configure other system parameters by interacting with user interface 406. For instance, in some situations, an administrator may centrally control user settings for users in a computer network. In such case, the administrator may be enabled to select values for one or more user settings, and to store the selected values in one or more packages in one or more user profiles.

User interface 406 may include any number and combination of user interface elements to enable the administrator to select the storage location for user profiles and to optionally configure further system parameters. Examples of such user interface elements include graphical icons, visual indicators, menus, radio buttons, check boxes, sliders, etc. An administrator at server 104 (or at other computing device coupled to server 104 through network 108) may be enabled to select the storage location for user profiles and to configure further system parameters in various ways by interacting with user interface 406, such as by navigating to a directory location, entering information in a text box, selecting information from a list or drop down menu, and/or in other ways.

Referring back to FIG. 3, in step 304, for at least one application on each computing device of a plurality of computing devices, a template is stored that is associated with the application. For instance, in an embodiment, application customizer 404 may store a template for one or more applications at one or more computing devices. For instance, referring to computing device 102a shown in FIG. 4, application customizer 404 may store template 120a in association with application 118a, and may store template 120b in association with application 118b. Each template identifies the corresponding application, may optionally indicate at least one application version for the identified application, and indicates locations where the application stores the user settings. In some cases, a template may be associated with multiple applications (e.g., for an application suite or applications that reference user settings as a functional group). In such cases, the template may identify each of the multiple applications, may optionally identify one or more application versions for each of the multiple applications, and may indicate locations where user settings locations are stored by the applications to configure each of the multiple applications with their corresponding user settings (e.g., common settings, if present). Further examples of templates are provided further below for illustrative purposes.

In step 306, for at least one application on each computing device of the plurality of computing devices, an agent is associated with a trigger mechanism, the agent configured to access the template associated with the application and to open a corresponding package at the selected storage location if the trigger mechanism is triggered. For instance, in an embodiment, application customizer 404 may associate an agent with a trigger mechanism for one or more applications at one or more computing devices. Referring to computing device 102a shown in FIG. 4, application customizer 404 may associate agent 122a with a trigger mechanism for application 118a, and may associate agent 122b with a trigger mechanism for application 118b. Agent 122a is configured with the selected storage location (selected in step 302) so that agent 122a can locate a package corresponding to application 118a in the central location.

An agent may be associated with any suitable type of trigger mechanism related to an application in any way. For instance, an agent may be inserted into a startup routine, into a shutdown routine, into a login routine, into a logoff routine, into at a lock routine, into an unlock routine, into a sleep routine, into a wake routine, into a session connect routine, a session disconnect routine, into a file open routine, into a file save routine, or into any other routine, process, or code associated with an application. An agent may be triggered on a periodic basis (e.g., by a clock or other timer) or on a non-periodic basis. An agent may be associated with trigger events that occur more or less often, depending how frequent it is desired to apply user settings to an application. For example, some settings that change more frequently (e.g., changing between week view and month view in a calendar application, changing between draft view and page view in a word processing application, etc.) may be desired to be triggered more frequently than settings that change less often (e.g., changing a background color setting in a word processing application, etc.).

Note that in one embodiment, application customizer 404 may perform steps 304 and 306 for an application by generating a template and agent for the application, copying the template and agent to the computing device, storing the template in a predetermined template storage location (that is known to the agent), and by inserting or storing the agent in a location to be associated with the trigger mechanism of the application.

In another embodiment, application customizer 404 may perform steps 304 and 306 for one or more applications at a computing device by installing a filter driver at the computing device. For instance, as shown in FIG. 4, application customizer 404 may install a filter driver 408 at computing device 102a. Filter driver 408 may be composed of one or more files that may operate as a process at computing device 102a. Filter driver 408 is configured to monitor applications at computing device 102a to determine whether the applications should be set up to access user settings as described herein. For instance, if filter driver 408 determines that a user is customizing user settings for application 118a, and/or determines that application 118a is accessing customized user settings stored on computing device 102a, filter driver 408 may automatically configure application 118a for access of user settings at the central location. For instance, in such a situation, filter driver 408 may automatically associate agent 122a with application 118a (installing agent in a routine that is a trigger mechanism, etc.), and may store template 120a in a predetermined template storage location on computing device 102a. Filter driver 408 may configure agent 122a to access template 120a for locations of user settings in application 118a, to access a corresponding package that contains values for the user settings at the central location, and to install the user settings in the application as described elsewhere herein.

B. Example Embodiments for Applying User Settings from Packages

As described above, in embodiments, applications can be configured with user settings automatically retrieved from packages in real-time. Such real-time configuring of applications with user settings can be performed in various ways. For instance, FIG. 5 shows a flowchart 500 providing a process for an agent configuring an application with user settings from in a package in response to a trigger mechanism being triggered, according to an example embodiment. Any of agents 118a-118d of FIG. 1 may operate according to flowchart 500, in an embodiment. For purposes of illustration, flowchart 500 of FIG. 5 is described with respect to FIG. 6. FIG. 6 shows a block diagram of a portion of communication system 100 of FIG. 1, in which an application is configured with user settings, according to an example embodiment. Computing device 102a and server 104 are shown in FIG. 4. As shown in FIG. 4, server 104 includes package distributer 112. Flowchart 500 and FIG. 6 are described as follows. Note that the steps of flowchart 500 may be performed in orders other than the order shown in FIG. 5. Further structural and operational embodiments will be apparent to persons skilled in the relevant art(s) based on the following description.

Flowchart 500 begins with step 502. In step 502, a template is accessed in response to a trigger mechanism being triggered with respect to an application in the computing device. With reference to FIG. 6, a trigger mechanism may be triggered with respect to application 118a in computing device 102a. For instance, application 118a may be invoked (startup), may be logged into, may be unlocked (e.g., for an operating system), or a trigger mechanism may be otherwise triggered. Agent 122a may detect the trigger mechanism being triggered due to being associated with the trigger mechanism (e.g., by being inserted in a startup routine for application 118a, etc.). In response to detecting this triggering, agent 112a may access template 120a that is associated with agent 112a and application 118a. Agent 112a may identify template 120a in a predetermined template directory in various ways, such as by a name and optionally a version of application 118a, which template 120a may use as a file name (e.g., “MicrosoftVisio2010Win32.xml” for a 32 bit 2010 version of Microsoft® Visio®), or agent 112a may identify template 120a in other ways.

Internally, template 120a may identify application 118a (e.g., by application name, identifier, etc.), may optionally indicate at least one version of application 118a, and may indicate locations (e.g., directory locations, file names, registry locations, etc.) to apply user settings to configure application 118a with one or more user settings. The user settings may be common to a suite of applications that includes application 118a, may be included in a functional group, and/or may be specific to application 118a.

In step 504, a package that includes the user settings is accessed at a storage location, the package included in a user profile that includes a plurality of packages that each includes user settings for one or more applications. For example, with reference to FIG. 6, agent 122a may be configured with a storage location for user profiles in storage 106. Package 116a may contain the user settings for application 118a for the user. As such, agent 122a may access package 116a in user profile 114a in storage 106 to obtain the user settings. For instance, agent 122a may attempt to open package 116a or otherwise access package 116a using package access 126. Package access 126 may indicate the storage location for packages in storage 106 that is known by agent 116a, along with a template identifier obtained from template 120a, which indicates a filename for package 116a in the storage location. Package distributer 112 may receive package access 126, and may provide package 116a to agent 122a in package response 128. Note that in the case of an application that is included in an application suite, agent 122a may access a first package (e.g., package 116b) that is an application suite package for common settings, and may access a second package (e.g., package 116a) that is an application-specific package that includes application-specific user settings.

In step 506, the user settings included in the package are applied to the application at the locations indicated in the template. For instance, in an embodiment, agent 116a is configured to apply the user settings included in package 116a to application 118a at the locations indicated for the user settings in template 120a. Any number of user settings may be applied to an application in this manner, including tens, hundreds, and even more user settings. The user settings may be applied at any locations for an application, including as registry settings in a registry, as files stored in directories, as entries made in a configuration file, etc. The user settings from the package may replace user settings that are already present, and these replaced user settings may be saved to be subsequently re-applied to the application (e.g., by an agent in response to another trigger occurrence).

Note that in the case of an application that is included in an application suite, agent 122a may apply the common user settings to the application from the application suite package, and then may apply the application-specific user settings to the application from the application-specific package. If a user setting is present in both the common and application-specific packages, by applying the application-specific user settings after the common user settings, the application-specific user setting that is present in both packages overwrites the common user setting. As such, the application-specific user settings override the common user settings. Alternatively, in another embodiment, the common settings may be applied after the application-specific user settings so that the common user settings override the application-specific user settings.

In this way, an application may be automatically configured with user settings in a manner that is consistent across multiple computing devices. Upon occurrence of a trigger, user settings may be applied to an application, while operation of the application is held up. For instance, a startup routine, a wake routine, an unlock routine, a login routine, etc., of the application may be interrupted or paused while the user settings are obtained and applied. After the user settings are applied to the application in response to the trigger, the application may be enabled to continue operating, with the applied user settings thereafter being used by the application.

Optionally, upon occurrence of another trigger (e.g., an opposing trigger such as a shutdown routine, a sleep routine, a lock routine, a logoff routine, etc.), the user settings may be collected from the application by an agent. For instance, the agent may access the corresponding template for locations of the user settings. The agent may collect the user settings from the indicated locations, and may optionally re-apply the original settings to the application (that were replaced by the user settings retrieved from the package), which the agent may have saved. The agent may provide the collected user settings to be stored in the package associated with the application at the central storage location. In this manner, the package stores the most up-to-date user settings for the application, including any user settings that the user may have changed while using the application since the user settings were applied.

Because the upload and download of user settings may be performed separately for each application, different settings can be defined to be handled differently from each other. For example, changed user settings such as bookmarks (e.g., in a browser) can be merged with their previous state in a package when stored in the package, whereas changed users settings such as background color can overwrite their previous setting instance in a package when stored in the package.

C. Example Embodiments for Templates

According to embodiments, templates, such as templates 120a-120d of FIG. 1, may be configured in various ways. For instance, a template may include information such as a name or other identifier for the corresponding application, may indicate a version or a range of versions for the corresponding application that the template is valid for, and may indicate locations for installation of the user settings obtained from the corresponding package. This information and/or additional/alternative information may be present in a template in any form. For example, a template may include such information in plain text, in formatted text, in the form a table, or in the form of program code such as HTML (hypertext markup language), XML (extensible markup language), or other code, or in other form.

For instance, an example of a template in XML form is shown below. The example template shown below is an application-specific template that corresponds to a package that contains application-specific user settings (e.g., package 116a shown in FIG. 2). Furthermore, the example template corresponds to a calculator application (Microsoft® Calculator):

<?xml version=“1.0” encoding=“UTF-8”?>
<SettingsLocationTemplate
xmlns=“http://schemas.microsoft.com/UserExperienceVirtualization/2012/SettingsLocati
onTemplate”>

<Name>Microsoft Calculator</Name>
<ID>MicrosoftCalculator6</ID>
<Version>0</Version>
<Processes>

<Process>

<Filename>CALC.EXE</Filename>
<ProductVersion>

<Major Maximum=“6” Minimum=“6”/>

</ProductVersion>

</Process>

</Processes>
<Settings>

<Registry>

<Path>Software\Microsoft\Calc</Path>

</Registry>

</Settings>

</SettingsLocationTemplate>

In this template example for a calculator application, the application name is provided (“Microsoft Calculator”), a template identifier is provided (“MicrosoftCalculator6”), an executable filename for the application is provided (“CALC.EXE”), a version for the application is provided (“6”), and a location for user settings for the application on the computing device is provided (“Software\Microsoft\Calc”). With regard to such an example, an agent for the application may access the template when triggered. The agent may use the template identifier (“MicrosoftCalculator6”) to identify the corresponding package at the centralized storage location, and may apply any user settings present in the package to the application at the indicated location for user settings (“Software\Microsoft\Calc”). The user settings may be stored in the package in the form of user setting identifier and value pairs, with the values being applied at the locations indicated in the template for their corresponding user setting identifiers.

Another example of a template in XML form is shown below. The example template shown below is an application suite template for an example application suite that corresponds to a first package that references common settings for an application suite (e.g., package 116b shown in FIG. 2) as well as additional packages that provide application-specific user settings. The example application suite is Microsoft® Office 2010, and this example template references a set of common settings (e.g., common settings 208 of FIG. 2) for the application suite. Furthermore, the template references application-specific settings (e.g., application-specific user settings 202 of FIG. 2) for multiple applications such as Microsoft® Access™ 2010, Microsoft® Excel® 2010, etc. (application-specific settings for just Microsoft® Access™ 2010 are shown below for purposes of brevity):

<?xml version=“1.0” encoding=“UTF-8”?>
<SettingsLocationTemplate
xmlns=“http://schemas.microsoft.com/UserExperienceVirtualization/2012/SettingsLocati
onTemplate”>

<Name>Microsoft Office 2010 (32-bit)</Name>
<ID>MicrosoftOffice2010Win32</ID>
<Common>

<Name>Common Settings</Name>
<ID>common</ID>
<Version>18</Version>
<Settings>
<PreventOverlappingSynchronization>

false </PreventOverlappingSynchronization>

<Registry>

<Path>Software\Microsoft\Office\14.0\Common
</Path>
<Name>Theme</Name>

</Registry>
<Registry>

<Path>Software\Microsoft\Office\14.0\Common\

AutoCorrect</Path>

<Name>ACOptions</Name>
<Name>CapitalizeNamesOfDays</Name>
<Name>CapitalizeSentence</Name>
. . .

</Registry>
. . .
<File>

<Root>

<EnvironmentVariable>APPDATA
</EnvironmentVariable>

</Root>
<Path>Microsoft\Office</Path>
<FileMask>*.acl</FileMask>

</File>
. . .

</Settings>

</Common>
<Application>

<Name>Microsoft Access 2010 (32-bit)</Name>
<ID>Access</ID>
<Version> 18</Version>
-<Processes>

<Process>

<Filename>MSACCESS.EXE</Filename>

<Architecture>Win32</Architecture>

<ProductVersion>

<Major Maximum=“14” Minimum=“14”/>
<Minor Maximum=“0” Minimum=“0”/>

</ProductVersion>
<FileVersion>

<Major Maximum=“14” Minimum=“14”/>
<Minor Maximum=“0” Minimum=“0”/>

</FileVersion>

</Process>

</Processes>
<Settings>

<Registry>

<Path>Software\Microsoft\Office\14.0\Access\File

MRU</Path>

</Registry>
<Registry>

<Path>Software\Microsoft\Office\14.0\Access\

Security\Crypto</Path>

<Name>CompatMode</Name>

</Registry>
. . .
<File>

<Root>

<EnvironmentVariable>LOCALAPPDATA

</EnvironmentVariable>

</Root>
<Path>Microsoft\Office</Path>
<FileMask>Access.officeUI</FileMask>

</File>

</Settings>

</Application>
. . .

</SettingsLocationTemplate>

In this template example for an application suite, the application suite name is provided (“Microsoft Office 2010 (32-bit)”), and a template identifier is provided (“MicrosoftOffice2010Win32”). Common user settings are indicated (e.g., as delimited by “<Common>” and “</Common>”), with locations for the common user settings on the computing device provided (e.g., “Software\Microsoft\Office\14.0\Common” being a location for the user setting “Theme”, etc.). Furthermore, for each application of the suite, application-specific settings are indicated (e.g., as delimited by “<Application>” and “</Application>” for each application). Each application name is provided (e.g., “Microsoft Access 2010 (32-bit)”), a template identifier is provided (“Access”), an executable filename for the application is provided (“MSACCESS.EXE”), and a version or version range for the application is provided (e.g., “14”). The common settings and user settings may be registry settings, files, etc.

With regard to such an example, an agent for the application may access the application suite template when triggered. The agent may use the template identifier for the application suite (“MicrosoftOffice2010Win32”) to identify the corresponding application suite package at the centralized storage location, and may use the template identifier for the particular application (“Access”) to identify the particular application-specific package at the centralized storage location. The agent may access and apply any common user settings present in the application suite package to the application, as well as accessing and applying any application-specific user settings present in the corresponding application-specific package for the application, at the indicated locations.

Another type of template described herein is a functional group template. A functional group template is a template for a functional group of settings that is accessible by multiple applications. Each application has a corresponding set of user settings in the functional group of user settings. A functional group template may be similar to an application suite template, such as shown above, with the addition of a tag or other indicator that indicates that although the functional group template is similar to an application suite template, the user settings in the functional group template are to be managed as group, rather than individually by different applications as in an application suite template. As such, in a functional group template, though, a single group of user settings (e.g., accessibility settings) may contain user settings that are controlled by different applications (e.g., different sections of user settings for the different applications are not visible in the template—these user settings are included in a single section).

For example, the following is an XML tag entry that may be included in a functional group template to indicate the template as a functional group template:

<ManageSuiteOnly>true</ManageSuiteOnly>
Such a tag may be included in a functional group template that otherwise looks like an application suite template (such as the example Microsoft® Office 2010 shown above), to indicate that the template is a functional group template.

Note that these examples of templates are provided for illustrative purposes, and are not intended to be limiting. In other embodiments, templates may be formatted in other ways, as would be apparent to persons skilled in the relevant art(s) from the teachings herein.

D. Example Application Embodiments

Applications 118a, 118b, 118c, and 118d, which execute at computing devices 102a and 102b of FIG. 1, encompass many types of applications. For instance, any of applications 118a-118d may be an office suite application, a desktop application, a mobile application, a web application, an operating system, or any other type of application capable of being run on a computing device. Office suite applications include various types of productivity enhancing applications, such as messaging applications, word processing applications, spreadsheet applications, presentation applications, etc. Desktop applications include various types of applications that configured to operate in computer desktops (e.g., of desktop computers), including some office suite applications, desktop widgets or gadgets (interactive tools that typically provide single purpose services, such as news streaming, providing the current weather, showing current stock quotes, etc.), etc.

A mobile application or “mobile app” is an application configured to run on a mobile device, which may be downloaded to a computing device through an application distribution platform or otherwise obtained. Examples of application distribution platforms for mobile apps include the Apple® App Store provided by Apple Inc. of Cupertino, Calif., Google® Play™ provided by Google Inc., California, the Microsoft® Windows® Phone Store provided by Microsoft Corp., the Microsoft® Store Online, and BlackBerry® App World™ provided by Research in Motion Limited of Waterloo, Ontario, Canada.

A web application may be an application that may be accessed by over a network (e.g., network 108), and/or may be an application that is coded in a browser-supported programming language (e.g., JavaScript, combined with a browser-rendered markup language such as HTML) and executes in a web browser to render the application executable. Examples of suitable web browsers include Internet Explorer®, developed by Microsoft Corp., Mozilla Firefox®, developed by Mozilla Corp. of Mountain View, Calif., Safari®, developed by Apple Inc., and Google® Chrome. Examples of applications that may be run in a browser and/or a mobile app interface include social networking applications, search engines, navigational assistance applications (e.g., mapping applications, restaurant locating applications, traffic applications, etc.), gaming applications, financial planning applications, etc.

An operating system is an application that is a collection of programs that manages computer hardware resources and provides common services for computer programs. Examples of operating systems include Microsoft® Windows® (e.g., Windows® 7, Windows® 8, Windows® Phone 8, etc.), Apple® OS X®, Apple® iOS, Google Android™, and Linux®.

D. Example Computing Device and Server Embodiments

Configuration interface 110, package distributer 112, applications 118a-118d, agents 122a-122d, application settings customization system 124, administrator interface 402, application customizer 404, filter driver 408, flowchart 300, and flowchart 500 may be implemented in hardware, or hardware combined with software and/or firmware. For example, configuration interface 110, package distributer 112, applications 118a-118d, agents 122a-122d, application settings customization system 124, administrator interface 402, application customizer 404, filter driver 408, flowchart 300, and/or flowchart 500 may be implemented as computer program code/instructions configured to be executed in one or more processors and stored in a computer readable storage medium. Alternatively, configuration interface 110, package distributer 112, applications 118a-118d, agents 122a-122d, application settings customization system 124, administrator interface 402, application customizer 404, filter driver 408, flowchart 300, and/or flowchart 500 may be implemented as hardware logic/electrical circuitry.

For instance, in an embodiment, one or more of configuration interface 110, package distributer 112, applications 118a-118d, agents 122a-122d, application settings customization system 124, administrator interface 402, application customizer 404, filter driver 408, flowchart 300, and/or flowchart 500 may be implemented together in a system-on-chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits and/or embedded firmware to perform its functions.

FIG. 7 depicts an exemplary implementation of a computing device 700 in which embodiments of the present invention may be implemented. For example, computing devices 102a and 102b, and/or server 104 may be implemented in one or more computing devices similar to computing device 700, including one or more features of computing device 700 and/or alternative features. The description of computing device 700 provided herein is provided for purposes of illustration, and is not intended to be limiting. Embodiments of the present invention may be implemented in further types of computer systems, as would be known to persons skilled in the relevant art(s).

As shown in FIG. 7, computing device 700 includes one or more processors 702, a system memory 704, and a bus 706 that couples various system components including system memory 704 to processor 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, RAMs, ROMs, and the like.

A number of program modules may be stored on the hard disk, magnetic disk, optical disk, ROM, or RAM. These programs include an operating system 730, one or more application programs 732, other program modules 734, and program data 736. Application programs 732 or program modules 734 may include, for example, computer program logic (e.g., computer program code or instructions) for implementing configuration interface 110, package distributer 112, applications 118a-118d, agents 122a-122d, application settings customization system 124, administrator interface 402, application customizer 404, filter driver 408, flowchart 300, and/or flowchart 500 (including any step of flowcharts 300 and 500), and/or further embodiments described herein.

A user may enter commands and information into the computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to, or incorporated in computing device 700. In addition to display screen 744, computing device 700 may include other peripheral output devices (not shown) such as speakers and printers.

Computing device 700 is connected to a network 748 (e.g., the Internet) through an adaptor or network interface 750, a modem 752, or other means for establishing communications over the network. Modem 752, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” and “computer-readable storage medium” are used to generally refer to media such as the hard disk associated with hard disk drive 714, removable magnetic disk 718, removable optical disk 722, as well as other media such as flash memory cards, digital video disks, RAMs, ROMs, and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 732 and other program modules 734) may be stored on the hard disk, magnetic disk, optical disk, ROM, or RAM. Such computer programs may also be received via network interface 750, serial port interface 742, or any other interface type. Such computer programs, when executed or loaded by an application, enable computing device 700 to implement features of embodiments of the present invention discussed herein. Accordingly, such computer programs represent controllers of the computing device 700.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for customizing user settings for applications, comprising:
selecting a storage location for storing user profiles, each user profile including one or more packages that each include user settings for one or more applications; and
for at least one application on at least one computing device,
storing a template associated with the application, the template identifying the application and indicating locations where the application stores the user settings, and
associating an agent with a trigger mechanism, the agent configured to access the template associated with the application and to open a corresponding package at the selected storage location if the trigger mechanism is triggered, the agent configured to apply the user settings included in the package to the application at the locations indicated in the template.

2. The method of claim 1, wherein said selecting comprises:
enabling an administrator to select the storage location.

3. The method of claim 1, wherein the package contains user settings specific to the application.

4. The method of claim 1, wherein the package is an application suite package that contains common user settings for applications in an application suite that includes the application.

5. The method of claim 1, wherein the package contains a functional group of user settings, the functional group of user settings accessible by a plurality of applications including the application, the applications of the plurality of applications each having a corresponding set of user settings in the functional group of user settings.

6. The method of claim 1, wherein said associating an agent with a trigger mechanism comprises at least one of:
inserting an agent into at least one of a startup routine or a shutdown routine of the application;
inserting an agent into at least one of a login routine or a logoff routine of the application;
inserting an agent into at least one of a lock routine or an unlock routine of the application;
inserting an agent into at least one of a sleep routine or a wake routine of the application; or
inserting an agent into at least one of a session connect routine or a session disconnect routine of the application.

7. A method in an agent in a computing device, comprising:
accessing a template in response to a trigger mechanism being triggered with respect to an application in the computing device, the template identifying the application and indicating locations where the application stores the user settings;
accessing a package that includes the user settings at a storage location, the package included in a user profile at the storage location that includes a plurality of packages that each include user settings for one or more applications; and
applying the user settings included in the package to the application at the locations indicated in the template.

8. The method of claim 7, wherein the package contains user settings specific to the application.

9. The method of claim 7, wherein the package is an application suite package that contains common user settings for applications in an application suite that includes the application.

10. The method of claim 7, wherein the package contains a functional group of user settings, the functional group of user settings accessible by a plurality of applications including the application, the applications of the plurality of applications each having a corresponding set of user settings in the functional group of user settings.

11. The method of claim 7, wherein the agent is included in at least one of a startup routine or a shutdown routine of the application, wherein said accessing comprises:
accessing the template in response to the startup routine or the shutdown routine of the application being invoked.

12. The method of claim 7, wherein the agent is included in at least one of a login routine or a logoff routine of the application, wherein said accessing comprises:
accessing the template in response to the login routine or the logoff routine of the application being invoked.

13. The method of claim 7, wherein the agent is included in at least one of a lock routine or an unlock routine of the application, wherein said accessing comprises:
accessing the template in response to the lock routine or the unlock routine of the application being invoked.

14. The method of claim 7, wherein the agent is included in at least one of a session connect routine or a session disconnect routine of the application, wherein said accessing comprises:
accessing the template in response to the session connect routine or the session disconnect routine of the application being invoked.

15. An application settings customization system in a server, comprising:
a configuration interface that includes
an administrator interface that enables a storage location to be selected for storing user profiles, each user profile including one or more packages that each include user settings for one or more applications; and
an application customizer configured
to store a template at a computing device in association with an application, the template identifying the application and indicating locations where the application stores the user settings, and
to associate an agent for the application with a trigger mechanism, the agent configured to access the template associated with the application and to open a corresponding package at the selected storage location if the trigger mechanism is triggered, the agent configured to apply the user settings included in the package to the application at the locations indicated in the template.

16. The application settings customization system of claim 15, wherein the application customizer is configured to install a filter driver at the computing device, the filter driver configured to automatically associate agents with applications at the computing device.

17. The application settings customization system of claim 15, wherein the package contains user settings specific to the application.

18. The application settings customization system of claim 15, wherein the package is an application suite package that contains common user settings for applications in an application suite that includes the application.

19. The application settings customization system of claim 15, wherein the package contains a functional group of user settings, the functional group of user settings accessible by a plurality of applications including the application, the applications of the plurality of applications each having a corresponding set of user settings in the functional group of user settings.

20. The application settings customization system of claim 15, further comprising:
a package distributer configured to respond to requests for packages from agents generated in response to trigger mechanisms being triggered with respect to applications.
